(19) United States
(12) Patent Application Publication
(10) Pub. No.: US 2009/0029238 A1
(43) Pub. Date: Jan. 29, 2009

(54) ELECTROCHEMICAL CELL HAVING POLYMERIC MOISTURE BARRIER

(76) Inventors: Mark A. Schubert, Medina, OH (US); Marc P. Kelemen, Westlake, OH (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 11/782,715

(22) Filed: Jul. 25, 2007

(51) Int. Cl. H01M 2/00; H01M 2/02; H01M 6/00

(52) U.S. Cl. 429/56; 429/174

(57) ABSTRACT

An alkaline electrochemical cell is provided which employs a polymeric moisture barrier material disposed in the collector assembly to substantially prevent the passage of moisture into the cell. The polymeric vapor barrier material may include a polyvinylidene chloride applied to the outer cover, the inner neutral cover, or the top side of the seal, to prevent the ingress and egress of moisture. The polyvinylidene chloride may be applied as a preformed thin sheet. The polymeric material exhibits a very low water vapor transmission rate of less than 1.0 (grams×mil)/(100 inches²×day) at 100° F. and 100 percent RH.

### BACKGROUND OF THE INVENTION

The present invention generally relates to electrochemical cells (i.e., batteries) and, more particularly, relates to a cell construction that prevents excessive moisture ingress.

Conventional alkaline electrochemical cells generally include a cell container in the form of a cylindrical steel can having a closed bottom end, a cylindrical side wall and an open top end. Disposed within the steel can is a positive electrode, also referred to as a cathode, and a negative electrode, also referred to as the anode. The cathode typically employs magnesium dioxide as the active material, while the negative electrode typically employs zinc powder as the active material. A separator is located between the anode and the cathode, and an aqueous alkaline electrolyte solution simultaneously contacts the anode, cathode, and separator. A collector assembly is assembled to the open end of the can to seal closed the open end. The collector assembly includes an annular polymeric (e.g., nylon) seal, a current collector and an outer cover in electrical contact with the collector. In some cells, the collector assembly further includes a grommet or an inner neutral cover that further radially supports the seal.

Conventional alkaline electrochemical cells typically include a vent mechanism, generally in the form of a reduced thickness portion of the annular polymeric seal. The reduced thickness vent mechanism is designed to rupture at a predetermined pressure differential to release high pressure gases as an intended cell safeguard. The outer cover and the inner neutral cover each include openings that allow for the vented gases to pass to the outside atmosphere. The conventional annular polymeric seal, particularly at the reduced thickness vent, is moisture permeable, such that moisture in the form of water vapor is able to permeate and pass through the polymeric (e.g., nylon) seal. The seal functions to prevent electrochemical materials contained inside the cell from leaking out of the can.

Under high humidity storage conditions, moisture ingress through the polymeric (e.g., nylon) seal causes the alkaline cell to absorb moisture. Contrarily, under low humidity storage conditions, moisture egress through the nylon seal causes the alkaline cell to lose moisture. The ingress and egress of moisture to and from the alkaline cell can lead to quality problems. For example, the ingress of excessive moisture through the seal increases the internal pressure of the cell, which accelerates the leakage of electrolyte, particularly along the surfaces of the seal. Electrolyte leakage from the can may be perceived as undesirable by users, such as when the label becomes demetalized due to corrosion caused by the electrolyte leakage.

There exist proposed techniques for reducing water vapor penetration into an electrochemical cell. For example, U.S. Pat. No. 6,022,635, entitled “ELECTROCHEMICAL CELL HAVING A MOISTURE BARRIER,” discloses the application of a moisture-impervious material made of asphalt or varnish disposed on the seal or on a surface of the outer cover. The aforementioned U.S. Patent is hereby incorporated herein by reference. These and other conventional moisture-impervious materials have been proposed for use in an electrochemical cell to limit moisture ingress. Some materials typically disclosed for use in a cell provide a water vapor barrier that exhibits a certain water vapor transmission rate (WVTR) and require a minimum thickness material to adequately prevent excessive moisture ingress, while other materials such as metal foil may be susceptible to corrosion from potassium hydroxide (KOH) and may suffer other drawbacks.

Accordingly, there exists a need for an electrochemical cell that effectively minimizes moisture ingress and egress to reduce the potential for cell leakage. There further exists a need for such an alkaline electrochemical cell that may utilize a cost affordable thin water vapor barrier material to achieve reduced water vapor permeation to prevent excessive moisture from entering the cell, particularly when subjected to high humidity conditions.

### SUMMARY OF THE INVENTION

The present invention provides for a cost-effective, non-corrodible, low volume and easy to assemble moisture barrier in an electrochemical cell to prevent excessive moisture ingress and egress and reduce potential cell leakage. To achieve these and other advantages, and in accordance with the purpose of the invention as embodied and described herein, an electrochemical cell is provided according to the present invention. According to one aspect of the present invention, the electrochemical cell includes a can having an open end and electrochemical materials including a first electrode and a second electrode provided inside the can. The cell has a seal provided in the open end of the can for preventing leakage of the electrochemical materials from within the can. The cell further includes a moisture barrier material applied as a preformed sheet to a component disposed in the open end of the can for preventing moist ambient air from reaching the sealed volume of the can. The moisture barrier material comprises a polymeric material and the moisture barrier material has a water vapor transmission rate less than 1.0 (grams×mil)/(100 inches²×day) at 100° F. and 100 percent RH.

According to another aspect of the present invention, the electrochemical cell includes a can having an open end and electrochemical materials including a first electrode and a second electrode provided inside the can. The cell has a seal provided in the open end of the can for preventing leakage of the electrochemical materials from within the can. The cell further includes a preformed sheet of moisture barrier material adhered to a component disposed in the open end of the can for preventing moist ambient air from reaching the sealed volume of the can.

According to a further aspect of the present invention, the electrochemical cell includes a can having an open end and electrochemical materials including a first electrode and a second electrode provided inside the can. The cell has a seal provided in the open end of the can for preventing leakage of the electrochemical materials from within the can. The cell further includes a moisture barrier material applied to a component disposed in the open end of the can for preventing moist ambient air from reaching the sealed volume of the can. The moisture barrier material comprises a polyvinylidene chloride and the moisture barrier material has a water vapor transmission rate less than 1.0 (grams×mil)/(100 inches²×day) at 100° F. and 100 percent RH.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a longitudinal cross-sectional view of an electrochemical cell employing a polymeric moisture barrier material according to a first embodiment of the present invention;

FIG. 2 is an enlarged cross-sectional view of the top portion of the cell shown in FIG. 1, further illustrating the polymeric moisture barrier material applied to the inside of the outer cover;

FIG. 3 is a cross-sectional view of the top portion of another electrochemical cell employing a polymeric moisture barrier material outside the outer cover, according to a second embodiment;

FIG. 4 is a cross-sectional view of a top portion of an electrochemical cell employing a polymeric moisture barrier material on the inside surface of the outer cover, according to a third embodiment;

FIG. 5 is a longitudinal cross-sectional view of the top portion of an electrochemical cell employing a polymeric moisture barrier material on the inside surface of the inner neutral cover, according to a fourth embodiment;

FIG. 6 is a longitudinal cross-sectional view of the top portion of an electrochemical cell employing a polymeric moisture barrier material on an outside surface of the outer cover, according to a fifth embodiment; and

FIG. 7 is a longitudinal cross-sectional view of the top portion of the electrochemical cell employing a polymeric moisture barrier layer on top of the annular nylon seal, according to a sixth embodiment.

### DETAILED DESCRIPTION OF PREFERRED EMBODIMENTS

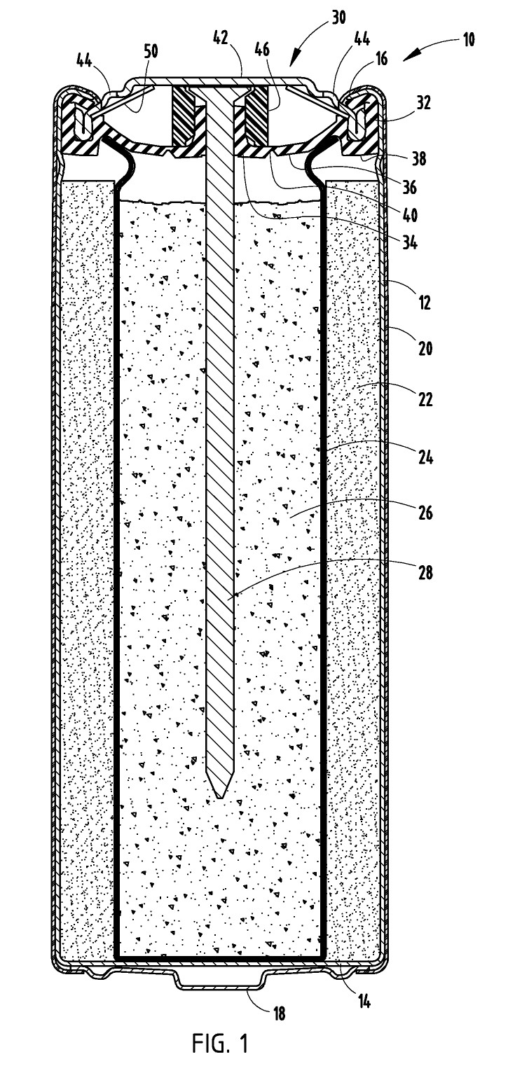

Referring to FIGS. 1 and 2, a cylindrical alkaline electrochemical cell 10 is illustrated having a polymeric moisture barrier material 50 applied to the cell 10 according to a first embodiment. The electrochemical cell 10 generally includes a cylindrical steel can 12, also referred to as a container, having a closed bottom end 14, an open top end 16, and a cylindrical side wall extending between the bottom and top ends. The closed bottom end 14 of can 12 has a positive contact terminal 18 welded or otherwise attached thereto and formed of plated steel, with an outward protruding nubbin provided at the central region, which forms the positive contact terminal of cell 10. Assembled to the open top end 16 of steel can 12 is a collector and seal assembly 30, which serves to seal closed the open end 14 of can 12 and also serves to collect electrical current.

The electrochemical cell 10, also includes a positive electrode 22, referred to as the cathode, and a negative electrode 26, also referred to as the anode, both disposed within a sealed volume of the steel can 12. In the disclosed embodiments, the electrodes are generally formed in a bobbin type configuration, with the cathode 22 formed as an outer electrode about the interior surface of steel can 12 in a generally tubular shape. According to one example, the cathode 22 may be formed of a mixture of manganese dioxide, graphite, potassium hydroxide (KOH), solution and additives. The cathode 22 may be formed using ring molding or impact molding cathode formation and assembling techniques.

A separator 24 is disposed about the interior surface of cathode 22 and may be cup-shaped with a side wall, a closed bottom wall, and an open top end according to an exemplary embodiment. The separator 24 may be formed of a non-woven fabric that prevents migration of solid particles between the anode 26 and cathode 22, as should be evident to those skilled in the art.

The anode 26 is disposed centrally within steel can 12 inside a separator 24 to form an inner electrode. The anode 26 may be a gel-type anode and consumes a generally cylindrical shape. The anode 26 may be disposed with an electrolyte, which may include an alkaline electrolyte containing potassium hydroxide (KOH). According to one example, the anode 26 may be formed of zinc powder, a gelling agent and additives. In the bobbin type cell configuration disclosed, the cathode 22 is configured as an outer electrode that serves as the cell's positive electrode, and the anode 26 is configured as an inner electrode that serves as the cell's negative electrode. In the specific example disclosed, the manganese dioxide and zinc employed in the cathode 22 and anode 26, respectively, are electrochemically active cell materials. It should be appreciated that other electrode configurations and electrochemically active cell materials and additives may be employed in the electrochemical cell 10 employing the moisture barrier material 50, according to the various embodiments of the present invention.

The collector and seal assembly 30, also referred to herein as the collector assembly, is shown in FIGS. 1 and 2 made up of an electrically conductive current collector 28, an annular seal (gasket) 32, a grommet 46, and an electrically conductive outer cover 42. The current collector 28 may include a brass nail that is welded or otherwise press fit to the interior surface of the outer cover 42 to provide electrical contact between the outer cover 42 and the collector 28. The outer cover 42 thereby serves as the negative contact terminal.

The polymeric annular seal 32 is in the form of a gasket and may be made of synthetic thermoplastic resin, such as polyamide 66, also referred to as nylon 66 resin. Seal 32 includes a central hub 34 defining a central opening through which the elongated collector nail 28 extends. Seal 32 also includes a peripheral portion 38 that is compressed against peripheral edges of the outer cover 42 during the can closure crimping process. Extending between the central hub 34 and peripheral portion 38 is a mid-section 36 of seal 32 that includes a reduced thickness vent 40. The reduced thickness vent 40 is intended to rupture upon experiencing a sufficient pressure differential. The nylon seal 32 generally has a water vapor transmission rate greater than 5.0 (grams×mil)/(100 inches²×day) at 100° F. and 100 percent relative humidity (RH). As a consequence of its permeability, the seal 32 also allows some moisture to permeate therethrough. In one example for an AA-size cell, the seal 32 is made of Zytel® nylon 66, commercially available from DuPont, which has an average mid-section thickness of approximately 20 mils, and at the vent 40 has a reduced thickness of about 7.5 mils, and a relatively high water vapor transmission rate of about 16 (grams×mil)/(100 inches²×day) at 77° F. and 100 percent RH.

Disposed about the central upstanding hub 34 of seal 32 is the grommet 46. The hub portion 34 of seal 32 is essentially squeezed between the collector nail 28 and the grommet 46 to minimize cell leakage between the collector 28 and seal 32.

The outer cover 42 generally includes a flat outer contact surface shown in the central portion that acts as the negative contact terminal of the cell 10. Radially outward of the negative contact terminal is a folded over peripheral portion of the outer cover 42 that sealingly engages the peripheral portion 38 of seal 32. The outer cover 42 is made of an electrically conductive material such as a copper alloy, brass or bronze with tin or indium plating/furnishing. The outer cover 42 further includes one or more vent hole openings 44 that allow gases released through vent 40 to exit from the cell 10 to the outside environment.

The electrochemical cell 10 further includes a metalized plastic film label 20 formed about the exterior surface of the steel can 12. The film label 20 may be formed over the peripheral edge of the positive cover 18 at the closed end 14 of can 12 and is further shown extending over the peripheral edge of the outer cover 42 at the opposite end 16. The label 20 is electrically insulative (i.e., dielectric) in the disclosed embodiment.

The electrochemical cell 10 further includes a polymeric moisture or water vapor barrier material 50 that impedes the ingress and egress of moisture, such as moisture in the form of vapor, into and out of the sealed volume of the cell 10. In the embodiment shown in FIGS. 1 and 2, the polymeric moisture barrier material 50 is shown as a thin sheet applied to the inside surface of the outer cover 42 covering the one or more vent holes 44. The polymeric sheet 50 may be attached to the inside surface of outer cover 42 by way of an adhesive, according to one embodiment or, may be ultrasonically welded or heat sealed, according to other embodiments. The thin sheet 50 may be in the shape of an angled ring or may include individual sheets applied to block individual vent openings 44. While the thin sheet 50 is shown as substantially flat (at an angle), it should be appreciated that the sheet 50 may be shaped to the contour of the inside surface of outer cover 42.

The polymeric moisture barrier material 50 advantageously prohibits the ingress and egress of moisture into and out of the cell 10 by preventing moisture from passing from the outside environment through the seal 32 and into the inside sealed volume of the cell 10. The polymeric moisture barrier material 50 is made of a polymeric material having a very low water vapor transmission rate. According to one embodiment, the polymeric material 50 is made up of polyvinylidene chloride (PVDC). Polyvinylidene chloride is commercially available in a preformed sheet under the brand name Saran™520 vapor retarder tape, commercially available from the Dow Chemical Company. In this embodiment, the Saran™ is available as a prefabricated sheet that may be adhered, such as via adhesive or ultrasonically to a component disposed in the open end 16 of the can 12. In the embodiment shown, the moisture barrier material 50 is applied to a component of the collector assembly 30 of cell 10. Polyvinylidene chloride has a very low water vapor transmission rate less than 1.0 (grams×mil)/(100 inches²×day) at 100° F. and 100 percent RH. According to one example, the Saran™ sheet 50 may have a PVDC thickness of about 2.0 mils and an acrylic adhesive of about 1.5 mils, for a total thickness of about 3.5 mils.

According to another embodiment, the polymeric moisture barrier material 50 may include a preformed sheet of polychlortrifluoroethylene (PCTFE) based polymeric film, sold under the brand name Clarus®, referred to specifically as Clarus® P2000TR film commercially available from Honeywell. The Clarus® P2000TR tape or film may be attached to a component of the collector assembly 30, such as by way of adhesive or ultrasonic welding. In one example, the sheet of Clarus® P2000TR film has a thickness of about 2.0 mils and is applied via NT-989-2 adhesive applied by Dielectric Polymers Inc. and exhibits a water vapor transmission rate of about 0.016 (grams×mil)/(100 inches²×day) at 100° F. and 100 percent RH.

According to a further embodiment, the polymeric material 50 may include a water based latex version of polyvinylidene chloride, commercially available under the brand name Diofan® XB201, which is commercially available from Solvay. In this example, the Diofan® XB201 PVDC may be applied with a thickness of about 2.0 mils, which may be applied as a liquid coating onto a component of the collector assembly 30 to prohibit moisture ingress and egress into and out of the cell 10. The Diofan® XB201 PVDC has a water vapor transmission rate of about 0.028 (grams×mil)/(100 inches²×day) at 100° F. and 90 percent RH.

Accordingly, the polymeric moisture barrier material 50 exhibits a very low water vapor transmission rate available in a thin layer, which advantageously prohibits the transmission of moisture therethrough and consumes a very small volume due to the thin make up of the material. The thickness of the polymeric moisture barrier material 50 in sheet form is preferably within a range of 0.5 to 5.0 mils, but may vary depending on the type of material. According to one embodiment, the moisture barrier material, particularly the polymeric moisture barrier material 50, has a water vapor transmission rate less than 1.0 (grams×mil)/(100 inches²×day) at 100° F. and 100 percent relative humidity (RH). According to another embodiment, the polymeric moisture barrier material 50 has a water vapor transmission rate of less than 0.1 (grams×mil)/(100 inches²×day) at 100° F. and 100 percent RH. According to a further embodiment the polymeric moisture barrier material 50 has a water vapor transmission rate of less than 0.05 (grams×mil)/(100 inches²×day) at 100° F. and 100 percent RH. The water vapor transmission rate values disclosed herein can be determined based on the known test procedures as should be evident to those skilled in the art.

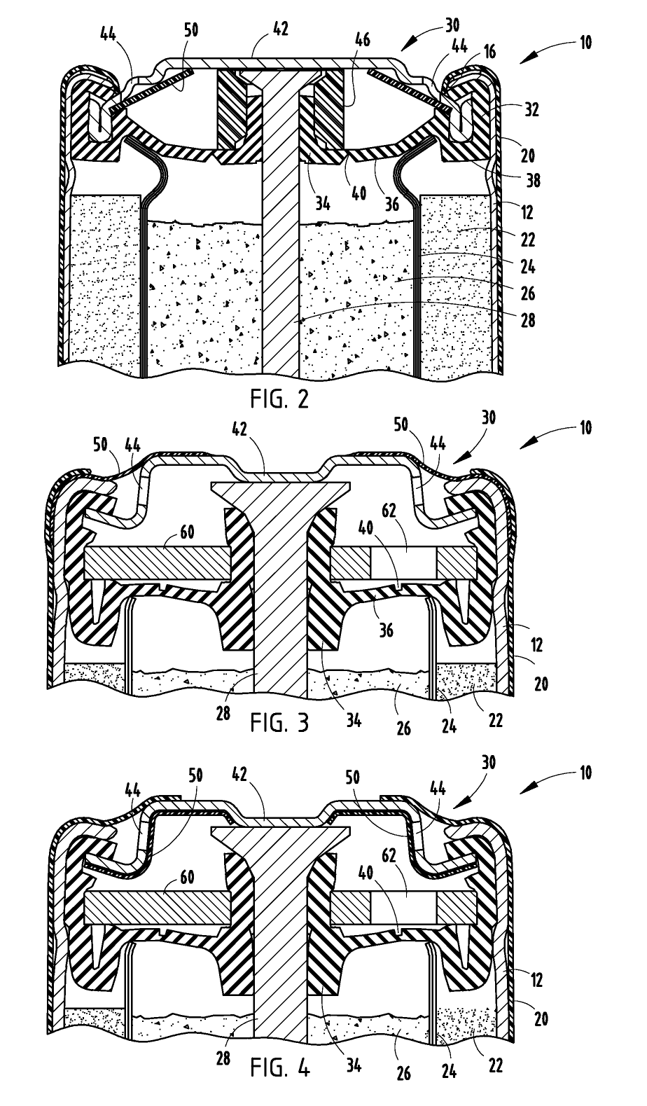

Referring to FIG. 3, an electrochemical cell 10 is illustrated employing an alternate collector assembly 30 and a polymeric moisture barrier material 50, according to a second embodiment. In this embodiment, the collector assembly 30 employs an elongated collector nail 28, an annular (gasket) seal 32, an inner neutral cover 60 and an outer cover 42. In contrast to the first embodiment, the neutral inner cover 60 provides radial structural support to support the seal 32 in place between the centrally located elongated brass nail 28 and the outer peripheral portion 38 of the seal against steel can 12. The inner neutral cover 60 may include a washer having one or more vent holes 62 formed therein, with the vent holes 62 aligned approximately with the reduced thickness vent 40 formed in seal 32. The outer cover 42 also has one or more vent holes 44 formed therein, as discussed above. The vent holes 44 and 66 allow for vented gases released through the seal vent 40 to pass to the outside environment.

In the embodiment shown in FIG. 3, a polymeric moisture barrier material 50 is shown in the form of a thin sheet applied on top of the outer cover 42 and over the open end 16 of steel can 12 on top of label 20. The polymeric moisture barrier material 50 may be adhered via adhesive or otherwise attached such as via ultrasonic welding to the two surfaces. With this arrangement, the polymeric moisture barrier material 50 forms a cover over the one or more vent holes 44 provided in outer cover 42. As a result, the polymeric material 50 prohibits moisture, including vapor, from passing through vent hole 44 from the outside environment, thus preventing the moisture from entering the cell 10.

Referring to FIG. 4, an electrochemical cell 10 is illustrated having a thin sheet of polymeric moisture barrier material 50 applied outer cover 42 of the current collector 30 according to a third embodiment. In this embodiment, the polymeric moisture barrier material 50 is applied to the underside of the outer cover 42 in a manner that conforms to the shape of the interior surface of the outer cover 42 to cover the one or more vent holes 44 formed in outer cover 42. The polymeric moisture barrier material 50 may be adhered via adhesive, ultrasonically welded or otherwise attached to the inner surface of outer cover 42. In this embodiment, the passage of moisture, such as vapor, through the one or more vent holes 44 in outer cover 42 is substantially prevented.

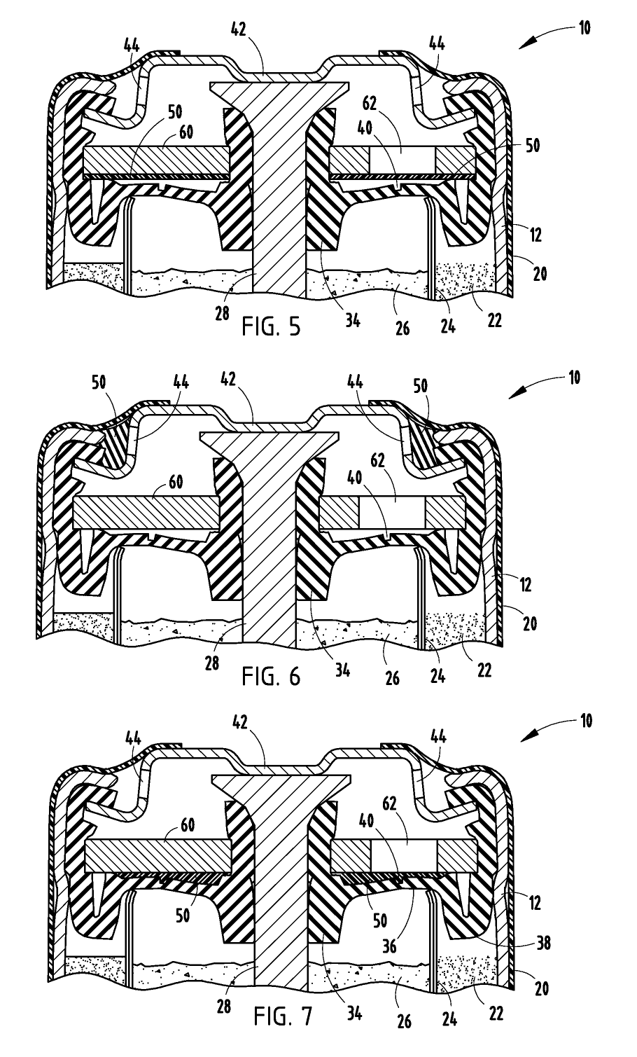

Referring to FIG. 5, a thin sheet of polymeric moisture barrier material 50 is shown applied to the underside of the inner neutral cover 60 so as to cover one or more vent holes 62 formed in inner cover 60. The polymeric moisture barrier material 50 may be attached to cover 60 by adhesive, ultrasonically welded or otherwise attached to the underside of the inner neutral cover 60. In this embodiment, the passage of moisture through the one or more vent holes 62 in cover 60 is substantially prohibited.

Referring to FIG. 6, a polymeric moisture barrier material 50 is applied to the outside surface of the outer cover 42 so as to cover the outside of the outer cover 42 where the one or more vent holes 44 are provided. In this embodiment, a thick layer of polymeric moisture barrier material 50 may be applied so as to substantially block the passage of moisture through the one or more vent holes 44 in outer cover 42. In this embodiment, the polymeric moisture barrier material 50 may include an ethylene vinyl acetate based hot melt adhesive, such as Bostik® Thermogrip® 2103, commercially available from Bostik Findley, Inc. The hot melt adhesive may be applied with a glue gun to form a cured material covering the one or more vent holes 44. According to other embodiments, other flowable materials, such as epoxy or UV curable acrylics, could be applied as material 50.

Referring to FIG. 7, an electrochemical cell 10 is illustrated having a polymeric moisture barrier material 50 disposed on the outside or top surface of the mid-section 36 of seal 32. In doing so, the polymeric moisture barrier material 50 covers the thin portion of the seal 32 in which the reduced thickness vent 40 is formed. Also, the barrier material may cover the bottom surface of the inner neutral cover 60 and the one or more vent holes 62 formed therein as shown. As a consequence, moisture such as vapor is substantially prevented from passing through the vent hole 62 and thus cannot readily permeate through the seal 32.

While the polymeric moisture barrier material 50 is shown and described herein applied to a component of the collector assembly within the open end of the can 12, it should be appreciated that the moisture barrier material 50 can be applied at other locations such as directly on top of the inner cover 60, and can be applied on multiple surfaces. For example, polymeric moisture barrier material 50 could be applied to both the top and bottom surfaces of the inner cover 60 so as to block the one or more vent openings 62. Additionally, it should be appreciated that while the moisture barrier material 50 includes a polymeric material in several embodiments, other materials may be combined with the polymeric material. The moisture barrier material 50 may include other materials including metallic and ceramic materials. For example, the moisture barrier material 50 may employ aluminum, silica or nickel foil. The resulting electrochemical cell 10 employing the polymeric moisture barrier material 50 advantageously achieves decreased moisture ingress rates, which results in less pressure buildup within the cell 10. The inclusion of the polymeric moisture barrier material 50 reduces label demetallization problems and may achieve a moisture ingress rate reduction of at least five times that without moisture barrier material 50, and is applied in a relatively thin application.

Accordingly, the electrochemical cell 10 according to various embodiments of the present invention advantageously employs a polymeric moisture barrier material 50 that exhibits a very low water vapor transmission rate. The polymeric moisture barrier material 50 may be provided as a thin sheet to a component of the collector assembly 30 that is disposed in the open end 16 of steel can 12. Additionally, the polymeric moisture barrier material 50 is not susceptible to corrosion from the alkaline electrolyte, particularly the potassium hydroxide. It should be appreciated, the polymeric moisture barrier material 50 may be applied as a very thin material which consumes only a small volume of the collector assembly 30, thereby leaving more usable volume within the cell 10 for the employment of electrochemically active materials.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. An electrochemical cell comprising:
a can having an open end;
electrochemical materials comprising a first electrode and a second electrode provided inside the can;
a seal provided in the open end of the can for preventing leakage of the electrochemical materials from within said can; and
a moisture barrier material applied as a preformed sheet to a component disposed in the open end of the can for preventing moist ambient air from reaching the sealed volume of the can, wherein the moisture barrier material comprises a polymeric material and the moisture barrier material has a water vapor transmission rate less than 1.0 (grams×mil)/(100 inches²×day) at 100° F. and 100 percent RH.

2. The electrochemical cell as defined in claim 1, wherein the moisture barrier material has a vapor transmission rate of less than 0.1 (grams×mil)/(100 inches²×day) at 100° F. and 100 percent RH.

3. The electrochemical cell as defined in claim 1, wherein the moisture barrier material has a water vapor transmission rate of less than 0.05 (grams×mil)/(100 inches²×day) at 100° F. and 100 percent RH.

4. The electrochemical cell as defined in claim 1, wherein the moisture barrier material has a thickness in the range of 0.5 to 5.0 mils.

5. The electrochemical cell as defined in claim 1, wherein the polymeric moisture barrier material comprises polyvinylidene chloride.

6. The electrochemical cell as defined in claim 5, wherein the polymeric moisture barrier material comprises a sheet of polyvinylidene chloride applied to the component.

7. The electrochemical cell as defined in claim 6, wherein the sheet is adhered to the component by ultrasonic welding.

8. The electrochemical cell as defined in claim 6, wherein the sheet is adhered to the component by an adhesive.

9. The electrochemical cell as defined in claim 1, wherein the seal has a water vapor transmission rate greater than 5.0 (grams×mil)/(100 inches²×day) at 100° F. and 100 percent RH.

10. The electrochemical cell as defined in claim 9, wherein the seal comprises a nylon gasket.

11. The electrochemical cell as defined in claim 1 further comprising a pressure relief vent formed in the seal to allow internal generated gases to vent when pressure inside the can becomes excessive.

12. The electrochemical cell as defined in claim 1 further comprising a cover provided in the open end of the can, wherein the cover comprises at least one aperture, and wherein the moisture barrier material prevents moist ambient air from passing through the at least one aperture.

13. The electrochemical cell as defined in claim 1 further comprising an outer cover provided in the open end of the can and an inner cover provided between the outer cover and the seal, wherein each of the outer cover and the inner cover comprises at least one aperture and, wherein the moisture barrier material prevents moist ambient air from passing through the at least one aperture of the inner cover.

14. The electrochemical cell as defined in claim 1, wherein the cell comprises an alkaline electrochemical cell.

15. An electrochemical cell comprising:
a can having an open end;
electrochemical materials comprising a first electrode and a second electrode provided inside the can;
a seal provided in the open end of the can for preventing leakage of the electrochemical materials from within said can; and
a preformed sheet of moisture barrier material adhered to a component disposed in the open end of the can for preventing moist ambient air from reaching the sealed volume of the can.

16. The electrochemical cell as defined in claim 15, wherein the preformed sheet of moisture barrier material comprises a polymeric moisture barrier material.

17. The electrochemical cell as defined in claim 16, wherein the sheet of polymeric moisture barrier material comprises polyvinylidene chloride.

18. The electrochemical cell as defined in claim 16, wherein the sheet of polymeric moisture barrier material comprises polychlortrifluoroethylene (PCTFE).

19. The electrochemical cell as defined in claim 15, wherein the sheet of moisture barrier material is adhered to the component by ultrasonic welding.

20. The electrochemical cell as defined in claim 15, wherein the sheet of moisture barrier material is adhered to the component by an adhesive.

21. The electrochemical cell as defined in claim 15, wherein the sheet of moisture barrier material has a thickness in the range of 0.5 to 5.0 mils.

22. The electrochemical cell as defined in claim 15, wherein the sheet of moisture barrier material has a water vapor transmission rate of less than 1.0 (grams×mil)/(100 inches²×day) at 100° F. and 100 percent RH.

23. The electrochemical cell as defined in claim 15, wherein the sheet of moisture barrier material has a water vapor transmission rate of less than 0.1 (grams×mil)/(100 inches²×day) at 100° F. and 100 percent RH.

24. The electrochemical cell as defined in claim 15, wherein the sheet of moisture barrier material has a water vapor transmission rate of less than 0.05 (grams×mil)/(100 inches²×day) at 100° F. and 100 percent RH.

25. The electrochemical cell as defined in claim 15, wherein the seal has a water vapor transmission rate greater than 5.0 (grams×mil)/(100 inches²×day) at 100° F. and 100 percent RH.

26. The electrochemical cell as defined in claim 25, wherein the seal comprises a nylon gasket.

27. The electrochemical cell as defined in claim 15, wherein a pressure relief vent is formed in the seal to allow internal generated gases to vent when pressure inside the can becomes excessive.

28. The electrochemical cell as defined in claim 15 further comprising a cover provided in the open end of the can, wherein the cover comprises at least one aperture, and wherein the preformed sheet of moisture barrier material is applied to the cover to block the at least one aperture.

29. The electrochemical cell as defined in claim 15 further comprising an outer cover provided in the open end of the can and an inner cover provided between the outer cover and the seal, wherein each of the outer cover and inner cover comprises at least one aperture, and wherein the preformed sheet of moisture barrier material is applied to the inner cover to block the at least one aperture in the inner cover.

30. The electrochemical cell as defined in claim 15, wherein the cell comprises an alkaline electrochemical cell.

31. An electrochemical cell comprising:
a can having an open end;
electrochemical materials comprising a first electrode and a second electrode provided inside the can;
a seal provided in the open end of the can for preventing leakage of the electrochemical materials from within said can; and
a moisture barrier material applied to a component disposed in the open end of the can for preventing moist ambient air from reaching the sealed volume of the can, wherein the moisture barrier material comprises a polyvinylidene chloride material and the moisture barrier material has a water vapor transmission rate less than 1.0 (grams×mil)/(100 inches²×day) at 100° F. and 100 percent RH.

32. The electrochemical cell as defined in claim 31, wherein the moisture barrier material has a vapor transmission rate of less than 0.1 (grams×mil)/(100 inches²×day) at 100° F. and 100 percent RH.

33. The electrochemical cell as defined in claim 31, wherein the moisture barrier material has a water vapor transmission rate of less than 0.05 (grams×mil)/(100 inches²×day) at 100° F. and 100 percent RH.

34. The electrochemical cell as defined in claim 31, wherein the moisture barrier material has a thickness in the range of 0.5 to 5.0 mils.

35. The electrochemical cell as defined in claim 31, wherein the polymeric moisture barrier material comprises a sheet of polyvinylidene chloride applied to the component.

36. The electrochemical cell as defined in claim 31, wherein the sheet is adhered to the component.

37. The electrochemical cell as defined in claim 31, wherein the polyvinylidene chloride is applied as a water based latex.

38. The electrochemical cell as defined in claim 31 further comprising a cover provided in the open end of the can, wherein the cover comprises at least one aperture, and wherein the moisture barrier material prevents moist ambient air from passing through the at least one aperture.

39. The electrochemical cell as defined in claim 31 further comprising an outer cover provided in the open end of the can and an inner cover provided between the outer cover and the seal, wherein each of the outer cover and the inner cover comprises at least one aperture and, wherein the moisture barrier material prevents moist ambient air from passing through the at least one aperture of the inner cover.

40. The electrochemical cell as defined in claim 31, wherein the cell comprises an alkaline electrochemical cell.
